(19) United States
(12) Patent Application Publication
(10) Pub. No.: US 2025/0390865 A1
(43) Pub. Date: Dec. 25, 2025

(54) System to Pause Electronic Fund Transfer by Time and QR Code Acceptance

(71) Applicant: Michael Vittone, San Pedro, CA (US)

(72) Inventor: Michael Vittone, San Pedro, CA (US)

(21) Appl. No.: 18/748,004

(22) Filed: Jun. 19, 2024

(51) Int. Cl. G06Q 20/38; G06K 7/14; G06Q 20/10; G06Q 20/32

(52) U.S. Cl. CPC G06Q 20/3821; G06K 7/1417; G06Q 20/10; G06Q 20/3276

(57) ABSTRACT

A system and method for pausing electronic fund transfers using machine-readable code authentication are disclosed. The system receives a request from a sender to initiate a fund transfer to a receiver, including transfer details and an indication to pause the transfer. A machine-readable code associated with the transfer is generated and transmitted to the receiver. The transfer is paused for a predetermined time period or until the code is scanned. Upon scanning or time period elapsing, the transfer is completed by transferring funds from the sender's account to the receiver's account based on the transfer details. The invention provides enhanced security and flexibility for controlling electronic fund transfers.

### BACKGROUND

The present invention relates generally to electronic funds transfer systems and methods. More specifically, the present invention relates to a system and method for facilitating secure electronic funds transfers with an intentional time delay and machine-readable code authentication.

Electronic funds transfer (EFT) systems have become increasingly popular due to the convenience and speed they offer compared to traditional payment methods such as cash or checks. EFT systems allow individuals and businesses to securely transfer money electronically between accounts, such as checking or savings accounts, using computer systems.

However, current EFT systems have limitations in terms of providing enhanced security and control over the timing of the funds transfer for the parties involved. For example, once an EFT transaction is initiated, the funds are typically transferred immediately or within a short time frame, without the ability for the sender to pause or delay the transfer until certain conditions are met by the recipient.

Some attempts have been made to provide increased security for EFT transactions. For instance, the “Verified by Visa” authentication service by Visa International provides an additional layer of security for online transactions by requiring the sender to enter a password to authenticate their identity before the transaction is authorized. However, this service does not provide the sender the ability to control the timing of the funds transfer after authentication.

Other payment services, such as escrow services or the manual payout feature offered by Stripe, allow a sender to delay payment to a recipient. However, escrow services have specific legal requirements and restrictions, and the manual payout feature is limited to certain time frames and does not provide additional authentication capabilities.

Therefore, there is a need for an improved electronic funds transfer system that provides senders with enhanced security and control over the timing of the funds transfer, while still facilitating efficient and convenient transactions for both senders and recipients. The present invention addresses this need by providing a novel system and method for pausing an electronic funds transfer until a machine-readable code is scanned by the recipient device or a predetermined time period elapses, combined with authentication of the sender's identity. This provides a useful way for senders to securely reserve funds for an intended recipient and control when the funds are ultimately released, without the limitations of existing services.

### SUMMARY

The present invention is directed to a system and method for pausing electronic fund transfers using machine-readable code authentication. The system includes a processor and memory that receives a request from a sender to initiate an electronic fund transfer to a receiver. The request includes transfer details and an indication to pause the transfer.

The system generates a machine-readable code, such as a QR code, associated with the fund transfer and transmits a notification of the pending transfer and the machine-readable code to the receiver. The system pauses the transfer for a predetermined time period set by the sender or until the machine-readable code is scanned by the receiver device.

Upon the machine-readable code being scanned or the time period elapsing, the system completes the fund transfer by transferring funds from the sender's account to the receiver's account based on the transfer details. The system then transmits a confirmation of the completed transfer to the sender and receiver.

In some embodiments, the sender can request to cancel the pending transfer before completion, and the system will cancel the transfer and send a cancellation notification to the receiver. If the time period elapses without the code being scanned, the system may prompt the sender to extend the time period or cancel the transfer.

The transfer details can include identifiers for the sender and receiver accounts, the transfer amount, and a memo. The system can also limit the number of times the machine-readable code can be scanned to complete the transfer. The sender and receiver accounts may be cryptocurrency wallets, bank accounts, credit card accounts, or debit card accounts.

In some embodiments, the system requires the sender to confirm the transfer before completion. The machine-readable code can also embed authentication information to automatically authenticate the receiver upon scanning the code.

The present invention provides an improved way to securely pause and control the timing of electronic fund transfers using machine-readable code scanning and authentication. This gives senders enhanced security and flexibility compared to traditional electronic transfer methods.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates a system diagram for pausing electronic fund transfers.

FIG. 2 is a flow diagram illustrating a computer-implemented method for pausing electronic fund transfers.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

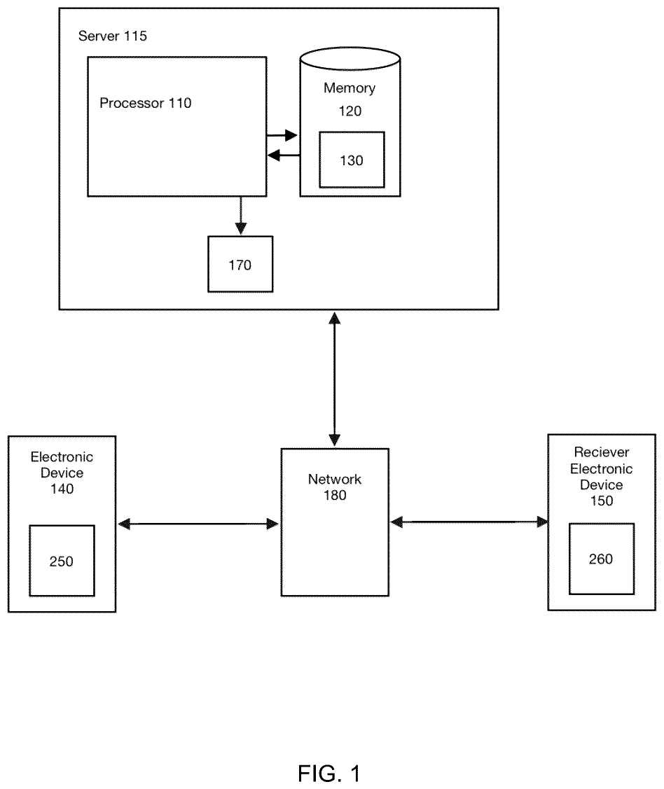

FIG. 1 illustrates a system diagram for pausing electronic fund transfers. The system includes a sender electronic device 140 and a receiver electronic device 150 which communicate with a central processing system over a network 180 using standard communication protocols such as TCP/IP, HTTP, or HTTPS. The network 180 may be the Internet, a cellular network, or any other type of network.

The central processing system comprises a server 115 containing a processor 110 coupled to a memory 120. The processor 110 may be a single or multi-core CPU such as those manufactured by Intel or AMD. The memory 120 may include both volatile memory such as RAM and non-volatile memory such as ROM, EEPROM, or flash memory. The memory 120 stores instructions 130 in the form of computer-readable code that, when executed by the processor 110, cause the system to perform various functions to facilitate pausing and completing electronic fund transfers. This code may be written in programming languages such as C++, Java, Python, or Node.js. When a user wishes to initiate an electronic fund transfer, they use a mobile app or web interface on the sender electronic device 140 to send a request to the server 115. This request is formatted as an API call and includes transfer details such as the amount to be transferred, the recipient's information, and an indication that the transfer should be paused. Upon receiving this API request, the server 115 generates a machine-readable code 170 associated with the specific electronic fund transfer.

In some embodiments, the machine-readable code 170 may be a QR code generated using a QR code library such as libqrencode. The server 115 then transmits a push notification to the receiver electronic device 150 using a push notification service such as Apple Push Notification service (APNs) or Firebase Cloud Messaging (FCM), informing the recipient of the pending electronic fund transfer. This notification also includes the machine-readable code 170 that was generated by the server. The electronic fund transfer is paused for a predetermined time period or until the machine-readable code 170 is scanned by the receiver electronic device 150.

The sender may specify the predetermined pause time period when initiating the transfer request using their sender electronic device 140. If the predetermined time period elapses without the machine-readable code 170 being scanned, the server 115 may send a notification to the sender electronic device 140 prompting the sender to either extend the pause period or cancel the pending transfer. These notifications may be implemented using websockets to enable real-time communication. When the recipient uses their receiver electronic device 150 to scan the machine-readable code 170 using a QR code scanner library like ZXing, or when the predetermined pause time period has elapsed, the server 115 completes the electronic fund transfer. This involves using an API provided by a payment processor such as Stripe or PayPal to transfer the specified funds from a sender account 250 associated with the sender to a receiver account 260 associated with the recipient based on the transfer details provided in the initial API request.

The sender account 250 and receiver account 260 may be various types of financial accounts including cryptocurrency wallets 261 managed by a digital wallet service like Coinbase, bank accounts 262 accessed via the Automated Clearing House (ACH) network, credit card accounts, or debit card accounts. The transfer details may include identifiers for the specific sender and receiver accounts as well as the transfer amount and an optional memo. In some embodiments, the machine-readable code 170 may be embedded with authentication information such as a digital signature. This allows the server 115 to automatically authenticate the receiver when they scan the code with their receiver electronic device 150 in order to complete the transfer. The digital signature may be generated and verified using asymmetric cryptography standards like RSA.

The sender may also specify a maximum number of times the machine-readable code 170 can be scanned to complete the transfer. The server 115 tracks the number of scans in a database and stops allowing the transfer to be completed via scanning once the maximum number is reached. Before finalizing the electronic fund transfer, the server 115 may transmit a request to the sender electronic device 140 for confirmation. Upon receiving this confirmation back from the sender device over a secure HTTPS connection, the transfer is completed. Once the electronic fund transfer has been successfully completed, the server 115 transmits confirmation notifications to both the sender electronic device 140 and the receiver electronic device 150. These may be delivered as SMS or email messages depending on user preferences. The sender also has the ability to cancel a pending transfer before it is completed. The sender electronic device 140 can send a cancellation API request to the server 115. The server then cancels the pending transfer, reverses any holds placed on funds in the sender account 250, and transmits a cancellation notification to the receiver electronic device 150.

In some embodiments, the intentional delay, pause or standby mode in the electronic fund transfer process is generated using artificial intelligence techniques. The server 115 includes a machine learning model 190 trained on historical transaction data to predict potentially fraudulent or high-risk transactions. When a new electronic fund transfer is initiated, the machine learning model 190 analyzes various parameters of the transaction, such as the transfer amount, the geographic location and transaction history of the sender and receiver, and the goods or services being purchased. If the model 190 flags the transaction as potentially high-risk, it automatically triggers the time-sensitive delay and the requirement for the receiver to scan the machine-readable code 170 before the transfer can proceed. This AI-based risk assessment adds an additional layer of security to prevent unauthorized or fraudulent transfers.

The server 115 may also include a rules engine 195 that allows senders or administrators to manually configure conditions that trigger the security delay features. For example, a sender may specify that all outgoing transfers above a certain dollar amount require approval via scanning the machine-readable code 170, or that all transfers to a particular recipient always require a minimum time delay before processing. These custom rules are stored in the memory 120 and executed by the rules engine 195 whenever a new transfer request is received. Thus, the intentional delay can be dynamically tailored to the specific security needs of each sender.

In various embodiments, the additional security layers of the electronic fund transfer system can be adapted to comply with relevant financial regulations and industry standards. For transfers involving cryptocurrency, the system may interface with a blockchain network 270 and smart contract platform such as Ethereum. Here, the transfer details and the requirement for the receiver to scan the machine-readable code 170 to complete the transfer are encoded into a smart contract 280. The smart contract 280 is deployed to the blockchain network 270, where it is executed by a distributed network of miners or validators 271. This ensures the transfer conditions are automatically enforced and immutably recorded on the blockchain ledger for auditing and compliance purposes.

For electronic fund transfers involving traditional fiat currency accounts such as bank accounts, the server 115 may communicate with financial institutions 290 via the ISO 20022 standard for electronic data interchange between financial services organizations. The transfer details and security requirements are encoded into ISO 20022 messages and transmitted to the sender and receiver's respective financial institutions over a secure inter-bank communication network 295 such as SWIFT or Fedwire. The financial institutions 290 then enforce the required time delay and machine-readable code scanning requirements before clearing the transfer, in compliance with the ISO 20022 specifications. This allows the enhanced security features to be seamlessly integrated into existing banking infrastructure and protocols.

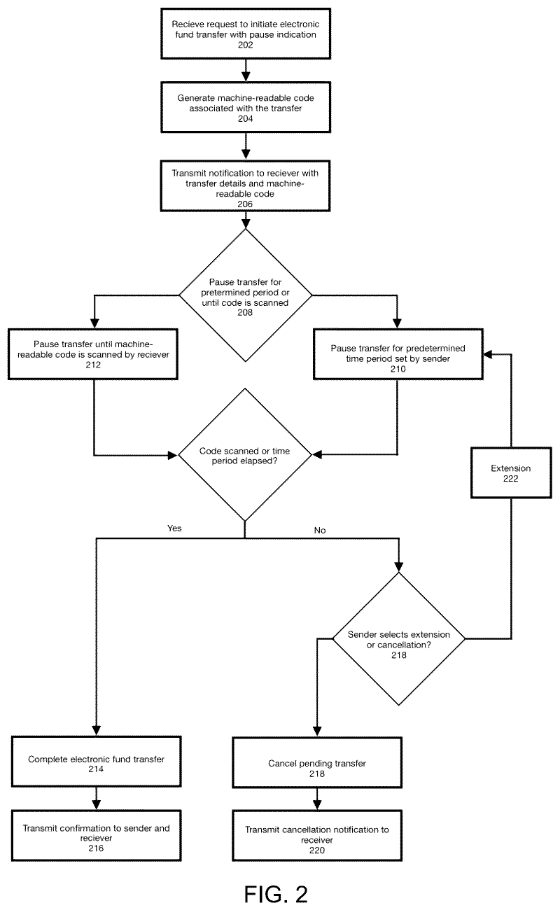

FIG. 2 is a flow diagram illustrating a computer-implemented method for pausing electronic fund transfers using the system 100 of FIG. 1. The method begins with the processor 110 receiving a request 160 from a sender electronic device 140 to initiate an electronic fund transfer to a receiver 202. The request 160 includes transfer details such as the amount to be transferred and a description of the purpose, as well as an indication 162 to pause the electronic fund transfer.

Upon receiving the request, the processor 110 generates a machine-readable code 170 associated with the electronic fund transfer 204. In some embodiments, the machine-readable code 170 is a QR code 171. The processor 110 then transmits a notification to the receiver electronic device 150 206. The notification includes the pending electronic fund transfer details and the machine-readable code 170.

The processor 110 pauses the electronic fund transfer for a predetermined time period set by the sender via the sender electronic device 140 when initiating the transfer 210. Alternatively, the processor 110 pauses the transfer until the machine-readable code 170 is scanned by the receiver electronic device 150 212. Pausing the transfer may comprise holding the funds in an escrow account 208.

When the machine-readable code 170 is scanned by the receiver electronic device 150 or the predetermined time period elapses, the processor 110 completes the electronic fund transfer by transferring funds 200 from an account 250 associated with the sender to an account 260 associated with the receiver based on the transfer detail 214. The accounts 250, 260 may be cryptocurrency wallets 261 or bank accounts 262. Upon completion, the processor 110 transmits confirmations 210 to the sender electronic device 140 and receiver electronic device 150 that the electronic fund transfer is completed. The confirmation includes a transaction identifier, the transfer details, and a timestamp 216.

The method provides several optional features. The processor 110 may receive a request from the sender electronic device 140 to cancel 218 the pending electronic fund transfer prior to the machine-readable code 170 being scanned or the time period elapsing. In this case, the processor 110 cancels the pending transfer and transmits a cancellation notification to the receiver electronic device 150 220.

If the predetermined time period elapses without the machine-readable code 170 being scanned, the processor 110 may transmit a notification to the sender electronic device 140 prompting the sender to select an extension 222 of the time period or cancel the pending transfer. The processor 110 may also receive an indication from the sender device 140 of a maximum number of times the machine-readable code 170 can be scanned to complete the transfer. The processor 110 tracks the number of scans and stops allowing the transfer to be completed when the maximum is reached.

For authentication, the processor 110 may transmit a request to the sender electronic device 140 to confirm the electronic fund transfer before completing it. The processor 110 receives the confirmation 310 and completes the transfer upon receiving it.

The method steps may be initiated via a mobile application executing on the sender electronic device 140. The central processing system comprises a server 115 that executes the method steps based on instructions 130 stored in memory 120.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

For example, the following are variations of the method described herein:

The method, further comprising:
receiving, by the processor from the sender electronic device, a cancellation request to cancel the electronic fund transfer;
cancelling, by the processor, the electronic fund transfer; and
transmitting, by the processor to the sender electronic device and the receiver electronic device, a notification that the electronic fund transfer has been cancelled.

The method, further comprising:
receiving, by the processor from the sender electronic device, an indication of a maximum number of times the machine-readable code can be scanned to complete the electronic fund transfer;
tracking, by the processor, a number of times the machine-readable code is scanned; and
stopping, by the processor, allowing the electronic fund transfer to be completed based on the machine-readable code scan when the maximum number of scans is reached.

The method, further comprising:
upon the predetermined time period elapsing without the machine-readable code being scanned, transmitting, by the processor to the sender electronic device, a notification that the electronic fund transfer has expired; and
refunding, by the processor, the funds to the account associated with the sender.

The method, wherein the transfer details comprise an amount to be transferred and a description of the purpose of the electronic fund transfer.

The method, wherein the request to initiate the electronic fund transfer is received via a mobile application executing on the sender electronic device.

The method, wherein the notification of the pending electronic fund transfer comprises the transfer details and a prompt to scan the machine-readable code to complete the electronic fund transfer.

The method, wherein the confirmation comprises a transaction identifier, the transfer details, and a timestamp indicating a time that the electronic fund transfer was completed.

The method, further comprising:
receiving, by the processor from the sender electronic device, a request to extend the predetermined time period;
transmitting, by the processor to the receiver electronic device, a notification of the request to extend the predetermined time period;
receiving, by the processor from the receiver electronic device, an approval of the request to extend the predetermined time period; and
extending, by the processor, the predetermined time period by a requested amount of time.

The method, further comprising:
before completing the electronic fund transfer, transmitting, by the processor, a request to the sender electronic device to confirm the electronic fund transfer;
receiving, by the processor, a confirmation from the sender electronic device; and
completing, by the processor, the electronic fund transfer upon receiving the confirmation.

The method, further comprising:
analyzing, using a machine learning model trained on historical transaction data, the transfer details to predict a risk score for the electronic fund transfer;
comparing the risk score to a threshold; and
automatically triggering the pausing of the electronic fund transfer and the requirement for the receiver to scan the machine-readable code when the risk score exceeds the threshold.

What is claimed is:

1. A system for pausing electronic fund transfers, the system comprising:
a processor;
a memory coupled to the processor, the memory storing instructions that,
when executed by the processor, cause the system to:
receive, from a sender electronic device, a request to initiate an electronic fund transfer to a receiver, the request comprising transfer details and an indication to pause the electronic fund transfer;
generate a machine-readable code associated with the electronic fund transfer;
transmit, to the receiver electronic device, a notification of the pending electronic fund transfer and the machine-readable code;
pause the electronic fund transfer for a predetermined time period or until the machine-readable code is scanned by the receiver electronic device;
upon the machine-readable code being scanned by the receiver electronic device or the predetermined time period elapsing, complete the electronic fund transfer by transferring funds from an account associated with the sender to an account associated with the receiver based on the transfer details; and
transmit, to the sender electronic device and the receiver electronic device, a confirmation that the electronic fund transfer is completed.

2. The system of claim 1, wherein the machine-readable code is a QR code.

3. The system of claim 1, wherein the predetermined time period is selected by the sender via the sender electronic device when initiating the electronic fund transfer request.

4. The system of claim 1, wherein the instructions further cause the system to:
receive, from the sender electronic device, a request to cancel the pending electronic fund transfer prior to the machine-readable code being scanned or the predetermined time period elapsing;
cancel the pending electronic fund transfer; and
transmit a cancellation notification to the receiver electronic device.

5. The system of claim 1, wherein the instructions further cause the system to:
upon the predetermined time period elapsing without the machine-readable code being scanned, transmit a notification to the sender electronic device prompting the sender to select an extension of the predetermined time period or cancel the pending electronic fund transfer.

6. The system of claim 1, wherein the transfer details comprise one or more of:
an identifier of the sender account, an identifier of the receiver account, a transfer amount, and a memo field.

7. The system of claim 1, wherein the instructions further cause the system to:
receive, from the sender electronic device, an indication of a maximum number of times the machine-readable code can be scanned to complete the electronic fund transfer;
track a number of times the machine-readable code is scanned; and
stop allowing the electronic fund transfer to be completed based on the machine-readable code scan when the maximum number of scans is reached.

8. The system of claim 1, wherein the sender account and receiver account are one or more of:
cryptocurrency wallets, bank accounts, credit card accounts, and debit card accounts.

9. The system of claim 1, wherein the instructions further cause the system to:
before completing the electronic fund transfer, transmit a request to the sender electronic device to confirm the electronic fund transfer;
receive a confirmation from the sender electronic device; and
complete the electronic fund transfer upon receiving the confirmation.

10. The system of claim 1, wherein the machine-readable code is embedded with authentication information, and scanning the machine-readable code using the receiver electronic device automatically authenticates the receiver to complete the electronic fund transfer.

11. The system of claim 1, further comprising a machine learning model trained on historical transaction data to predict potentially fraudulent or high-risk transactions, wherein the instructions further cause the system to:
analyze, using the machine learning model, the transfer details to determine a risk score for the electronic fund transfer;
compare the risk score to a threshold; and
automatically trigger the pausing of the electronic fund transfer and the requirement for the receiver to scan the machine-readable code when the risk score exceeds the threshold.

12. The system of claim 1, further comprising a rules engine configured to execute custom security rules, wherein the instructions further cause the system to:
receive, from the sender electronic device or an administrator, one or more custom security rules specifying conditions that trigger pausing the electronic fund transfer;
store the one or more custom security rules in the memory; and
execute, using the rules engine, the one or more custom security rules to determine whether to pause the electronic fund transfer.

13. The system of claim 8, wherein the sender account and the receiver account are cryptocurrency wallets, and wherein the instructions further cause the system to:
generate a smart contract comprising the transfer details and the requirement for the receiver to scan the machine-readable code to complete the electronic fund transfer;
deploy the smart contract to a blockchain network; and
complete the electronic fund transfer by executing the smart contract on the blockchain network upon the machine-readable code being scanned.

14. The system of claim 8, wherein the sender account and the receiver account are bank accounts, and wherein the instructions further cause the system to:
generate one or more ISO 20022 messages comprising the transfer details and the requirement for the receiver to scan the machine-readable code to complete the electronic fund transfer; and
transmit the one or more ISO 20022 messages to financial institutions associated with the sender account and the receiver account via a secure inter-bank communication network.

15. A computer-implemented method for pausing electronic fund transfers, the method comprising:
receiving, by a processor from a sender electronic device, a request to initiate an electronic fund transfer to a receiver, the request comprising transfer details and an indication to pause the electronic fund transfer;
generating, by the processor, a machine-readable code associated with the electronic fund transfer;
transmitting, by the processor to the receiver electronic device, a notification of the pending electronic fund transfer and the machine-readable code;
pausing, by the processor, the electronic fund transfer for a predetermined time period or until the machine-readable code is scanned by the receiver electronic device;
upon the machine-readable code being scanned by the receiver electronic device or the predetermined time period elapsing, completing, by the processor, the electronic fund transfer by transferring funds from an account associated with the sender to an account associated with the receiver based on the transfer details; and
transmitting, by the processor to the sender electronic device and the receiver electronic device, a confirmation that the electronic fund transfer is completed.

16. The method of claim 15, wherein the machine-readable code is a QR code.

17. The method of claim 15, wherein the predetermined time period is set by the sender via the sender electronic device when initiating the electronic fund transfer.

18. The method of claim 15, wherein pausing the electronic fund transfer comprises holding the funds in an escrow account.

19. The method of claim 15, further comprising:
receiving, by the processor from the sender electronic device, a request to cancel the pending electronic fund transfer prior to the machine-readable code being scanned or the predetermined time period elapsing;
cancelling, by the processor, the pending electronic fund transfer; and
transmitting, by the processor, a cancellation notification to the receiver electronic device.

20. The method of claim 15, further comprising:
upon the predetermined time period elapsing without the machine-readable code being scanned, transmitting, by the processor, a notification to the sender electronic device prompting the sender to select an extension of the predetermined time period or cancel the pending electronic fund transfer.
